(19) United States
(12) Patent Application Publication
(10) Pub. No.: US 2026/0206065 A1
(43) Pub. Date: Jul. 16, 2026

(54) RANDOM ACCESS REPORTING METHOD AND USER EQUIPMENT

(71) Applicant: Sharp Kabushiki Kaisha, Sakai City, Osaka (JP)

(72) Inventors: Ningjuan CHANG, Shanghai (CN); Renmao LIU, Shanghai (CN)

(21) Appl. No.: 19/132,962

(22) PCT Filed: Nov. 30, 2023
(86) PCT No.: PCT/CN2023/135445

§ 371 Date: May 27, 2025

(30) Foreign Application Priority Data
Dec. 2, 2022 (CN) 202211546160.7

(51) Int. Cl. H04W 74/0833

(52) U.S. Cl. CPC H04W 74/0833

(57) ABSTRACT

Provided in the present disclosure are a random access reporting method and a user equipment. The random access reporting method includes: initiating, by a user equipment (UE), a small data transmission (SDT) procedure; determining, by the UE, that the SDT procedure is completed or a random access (RA) procedure in the SDT procedure is completed; and storing, by the UE, SDT information in an RA report, wherein the SDT information includes at least one of the following information: first information, used to indicate whether the SDT procedure is successfully completed; and second information, used to indicate whether the RA procedure in the SDT procedure is successfully completed.

### TECHNICAL FIELD

The present disclosure relates to the technical field of wireless communications. More specifically, the present disclosure relates to a random access reporting method and a corresponding user equipment.

### BACKGROUND ART

Network optimization can be performed in a wireless network to achieve the goal of optimizing network performance. Generally, techniques such as data acquisition and data analysis are used to ascertain the causes of poor network quality in existing deployed and operating networks, and techniques such as modifying configured network parameters and adjusting the network structure and deployed devices are adopted to improve network performance. In a self-configuration and self-optimization network (SON), optimization refers to a process of automatically adjusting the network on the basis of measurement/performance measurement of user equipment and/or a base station. The network side can configure the UE to execute measurement for a SON. There are many SON functions, e.g., an automatic neighbor relation (ANR) function for reducing the neighbor cell management burden of an operator, a mobility load balancing (MLB) function for balancing loads among different cells, a mobility robustness optimization (MRO) function for optimizing mobility performance, a random access channel optimization function for optimizing random access channel parameters, and a radio link failure report function for optimizing coverage and MRO.

In addition, the minimization of drive tests (MDT) technology is also an important means for operators to optimize networks. Network optimization related parameters are acquired from drive test data obtained by the UE, and a network deployment status and an operation status are acquired based on analysis on the data, so as to decide how to improve the network operation status. Main application scenarios of MDT are coverage optimization, capacity optimization, mobility management optimization, QoS parameter optimization, common channel parameter configuration optimization, etc.

In a system of release 17 or earlier versions, a random access (RA) report is used to record information about a random access procedure executed on a UE side, so as to optimize random access parameters, network coverage, and other issues on a network side.

A small data transmission (SDT) mechanism is introduced to an NR system of release 17. This mechanism aims to optimize signaling overhead and power consumption resulted from infrequent transmission of small data traffic by users. For a user equipment (UE) in a radio resource control inactive state (RRC_INACTIVE), transmission of infrequent small data traffic (such as instant information, keep-alive heartbeat signals, periodic information of a smart wearable device or a sensor, and periodic meter reading traffic from a smart metering device) requires the UE to enter a radio resource control connected state, namely, RRC_CONNECTED state in order to execute transmission of small data packets, and signaling overhead resulted from such transmission deteriorates network performance and leads to a massive amount of energy consumption of the UE. Therefore, small data transmission in the RRC_INACTIVE state can be implemented through the SDT mechanism for such traffic, thereby preventing the above problems.

The present disclosure is intended to achieve random access information reporting in an NR network, and further achieve RA reporting in an SDT-supported network.

### SUMMARY OF THE INVENTION

A main objective of the present disclosure is to provide an RA reporting method and a user equipment, so that reporting of SDT-related performance information can be implemented in an SDT-supported system, and random access information configuration for RA reporting can be implemented in an SDT scenario.

According to a first aspect of the present disclosure, an RA reporting method is provided, comprising: initiating, by a user equipment (UE), a small data transmission (SDT) procedure; determining, by the UE, that the SDT procedure is completed; and storing, by the UE, SDT information in an RA report, wherein the RA information includes one or more of the following information: first information, used to indicate whether the SDT procedure is successfully completed; second information, used to indicate whether an RA procedure in the SDT procedure is successfully completed; third information, used to indicate whether the RA procedure is the first RA procedure in the SDT procedure; fourth information, used to indicate a cause of a failure of the SDT procedure; fifth information, used to indicate whether the failure of the SDT procedure occurs during initial transmission or subsequent transmission; and sixth information, used to indicate whether the RA procedure occurs during the SDT procedure.

In the RA reporting method of the first aspect, the SDT procedure is a random access-SDT procedure (RA-SDT).

In the RA reporting method of the first aspect, a completion of the SDT procedure is either a successful completion or a failed completion.

In the RA reporting method of the first aspect, the UE stores the SDT information in the RA report when determining that the random access procedure in the SDT procedure is completed.

In the RA reporting method of the first aspect, when a value of a raPurpose field in the RA report is set to ulUnSynchronized or noPUCCHResourceAvailable, the UE includes the sixth information in the RA report.

In the RA reporting method of the first aspect, the UE receives, from a base station, a UE information request (UEInformationRequest) message, which includes an indication for requesting the UE to report the stored RA report; and the UE sends, to the base station based on the indication and in a UE information response (UEInformationResponse) message, the stored RA report including one or more of the first information to the sixth information.

In the RA reporting method of the first aspect, the initial transmission is the first physical uplink shared channel (PUSCH) transmission in the SDT procedure, and refers to transmission of a data packet including both a common control channel (CCCH) message and user plane data; and the subsequent transmission refers to transmission in the SDT procedure of a data packet not transmitted together with the common control channel (CCCH) message, and the subsequent transmission starts after the initial transmission is successfully completed.

In the RA reporting method of the first aspect, the failed completion of the SDT procedure means that the UE considers that an ongoing SDT procedure is changed to a non-ongoing state; and the failed completion of the SDT procedure is present when one or more of the following cases occur: the UE in the SDT procedure receives an RRC rejection message from a network side; a timer T319a times out; an indication of a failure of the RA procedure is received from a lower layer during the SDT procedure; an indication of the maximum number of retransmissions being reached is received from a radio link control layer (RLC) of a master cell group while the SDT procedure is ongoing; an indication of an integrity check failure is received from the lower layer while the SDT procedure is ongoing; and while the SDT procedure is ongoing, the lower layer indicates that a timer cg-SDT-TimeAlignmentTimer or a timer configuredGrantTimer times out before a network response sent with respect to uplink CG-SDT is received.

According to a second aspect of the present disclosure, a user equipment is provided, comprising: a processor; and a memory storing instructions, wherein the instructions, when run by the processor, execute the above RA reporting method.

### EFFECT OF INVENTION

According to the RA reporting method executed by a user equipment and the user equipment in the present disclosure, reporting of SDT-specific performance information different from RA information corresponding to an RA transmission procedure can be implemented in an SDT-supported system, and random access information configuration for RA reporting can be implemented in an SDT scenario. In this way, the network side can differentiate between an RA procedure in an SDT scenario and that in a conventional non-SDT scenario. In addition, based on the SDT-specific information, such as information about whether an SDT procedure is successful, an occurrence of an SDT failure/RA failure in a subsequent SDT phase, the network side can analyze random access performance and SDT configurations in the SDT scenario and perform more refined optimization on parameter configurations.

### BRIEF DESCRIPTION OF THE DRAWINGS

The above and other features of the present disclosure will become more apparent with the following detailed description in conjunction with the accompanying drawings.

FIG. 1 is a schematic flowchart of a contention-based four-step random access procedure.

FIG. 2 is a schematic flowchart of a contention-free random access procedure.

FIG. 3 is a schematic flowchart showing a random access-SDT procedure.

FIG. 4 is a schematic flowchart showing an SDT procedure based on a CG-SDT mechanism.

FIG. 5 is a schematic flowchart showing an RA reporting method according to Embodiment 1 of the present invention.

FIG. 6 is a schematic flowchart showing an RA reporting method according to Embodiment 2 of the present invention.

FIG. 7 is a schematic flowchart showing an RA reporting method according to Embodiment 3 of the present invention.

FIG. 8 is a schematic flowchart showing an RA reporting method according to Embodiment 4 of the present invention.

FIG. 9 is a schematic flowchart showing an RA reporting method according to Embodiment 5 of the present invention.

FIG. 10 is a schematic flowchart showing an RA reporting method according to Embodiment 6 of the present invention.

FIG. 11 shows a block diagram of a user equipment according to an embodiment of the present disclosure.

### DETAILED DESCRIPTION OF PREFERRED EMBODIMENTS

According to the following detailed description of exemplary embodiments of the present disclosure made in conjunction with the accompanying drawings, other aspects, advantages, and prominent features of the present disclosure will become apparent to those skilled in the art.

In the present disclosure, the terms “include” and “comprise” and derivatives thereof mean inclusion and not limitation. The term “or” has an inclusive meaning and means “and/or”.

In the present specification, the following various embodiments for describing the principles of the present disclosure are merely illustrative, and should not be interpreted in any way as limiting the scope of the disclosure. The following description with reference to the accompanying drawings is used to facilitate full understanding of the exemplary embodiments of the present disclosure defined by the claims and equivalents thereof. The following description includes a variety of specific details to facilitate understanding, but these details should be considered merely exemplary. Therefore, those of ordinary skill in the art should recognize that various changes and modifications may be made to the embodiments described herein without departing from the scope and spirit of the present disclosure. In addition, the description of the known function and structure is omitted for clarity and simplicity. In addition, the same reference numerals are used for similar functions and operations throughout the accompanying drawings.

A plurality of implementations according to the present disclosure are specifically described below by using an NR mobile communication system as an example application environment. However, it is to be noted that the present disclosure is not limited to the following implementations, and is applicable to other wireless communications systems, such as an LTE system connected to a 5G core network.

A base station in the present disclosure may be any type of base station, including a Node B, an enhanced base station eNB, or a base station gNB in a 5G communication system; or a micro base station, a pico base station, a macro base station, or a home base station, etc; The network side is generally referred to as a base station. The cell may also be a cell covered by any type of the base station described above. Unless otherwise specially stated, a cell, a beam, and a transmission point (TRP) may be interchanged. The base station may also be a gNB-central unit (gNB-CU) or a gNB-distributed unit (gNB-DU) that forms a base station. An LTE system may also refer to a 5G LTE system and a post-5G LTE system (such as an LTE system referred to as an eLTE system or an LTE system that can be connected to a 5G core network). In addition, the LTE can be replaced with an evolved universal terrestrial radio access (E-UTRA) or an evolved universal terrestrial radio access network (E-UTRAN). Different embodiments may also be combined with each other for operation. For example, the same variables/parameters/nouns in different embodiments may be interpreted identically. “Cancel”, “release”, “delete”, “clear”, and “remove” are interchangeable. “Execute”, “use”, and “apply” are interchangeable. “Configure” and “reconfigure” are interchangeable. “Monitor” and “detect” are interchangeable. “Initiate” and “trigger” are interchangeable.

Some existing mechanisms involved in the present disclosure are first described below. It is worth noting that some names in the following description are merely illustrative of examples rather than limiting, and other names may be used.

Physical random access channel resource: PRACH resource. A base station broadcasts, by means of system information, a physical random access channel parameter configuration used by a cell. In the present disclosure, a physical random access channel resource (PRACH resource) may refer to a physical frequency resource and/or time domain resource and/or code domain resource (e.g., a preamble) for random access.

Random access channel: A random access channel (RACH) refers to a channel for sending a random access preamble. In the present disclosure, the RACH may refer to a transport channel RACH, and may also refer to a physical random access channel (PRACH), with no differentiation made between them. RACH parameters/configurations refer to wireless configurations for implementing random access functions, including PRACH-related configurations, such as the maximum number of preambles sent, a power ramping parameter, a random access response reception window size, a MAC contention resolution timer configuration, a PRACH time-frequency resource configuration, a message 1 (i.e., preamble) sub-carrier spacing, a configuration (configured by an ssb-perRACH-OccasionAndCB-PreamblesPerSSB information element) for indicating information about the number of synchronization signal blocks (SSBs) corresponding to each RACH occasion (RO) and the number of contention-based random preambles corresponding to each SSB, a backoff parameter (in a scalingFactorBI information element), etc.

### Random Access (RA) Procedure:

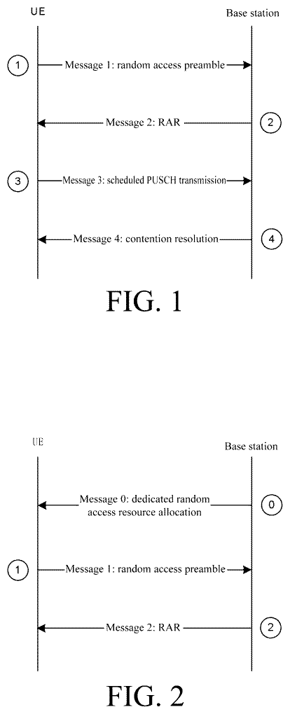

In existing NR mechanisms, random access procedures may be divided into contention-based random access (CBRA) and contention-free random access (CFRA). As shown in FIG. 1, a CBRA procedure is divided into four steps: step 1: a UE sends a message 1 (i.e., a random access preamble) to a base station; step 2: the UE receives a message 2 (i.e., a random access response, RAR) from the base station; step 3: the UE sends a message 3 (uplink transmission scheduled by an uplink grant in the message 2), wherein the message 3 is generally used to send, to the base station, a UE identity, a radio resource control (RRC) message used for RRC connection establishment/resume/reestablishment, a UE contention resolution identifier for random access contention resolution, etc.; and step 4: the UE receives a message 4 (i.e., a message for contention resolution) from the base station. The PRACH resources used in CBRA are shared by many UEs. After the UE completes the above-described four steps of random access of CBRA and contention resolution succeeds, the random access procedure is successfully completed. As shown in FIG. 2, a CFRA procedure is divided into two steps: step 1: a UE sends a message 1 (i.e. a random access preamble) to a base station; and step 2: the UE receives a message 2 (i.e., a random access response, RAR) from the base station. After successfully receiving message 2 associated with message 1, the UE considers that the CFRA procedure is successfully completed. In CFRA, a base station generally allocates a dedicated PRACH resource such as a preamble to a UE in advance (referred to as step 0 in FIG. 2), so that no contention is present. The two-step random access procedure is introduced to NR of R16 or later versions. Step 1 and step 3 in the above four-step random access procedure are combined into one step for sending, which is referred to as a message A. That is, the message A contains a random access preamble and a subsequently associated PUSCH load. Content of the PUSCH load is consistent with content contained in the message 3. The content of the PUSCH load may contain an RRC message, or may contain user plane data or a MAC control element such as a buffer status report or a UE identity, etc. Step 2 and step 4 are combined into one step, which is referred to as a message B. The message B is a response to the message A in the two-step random access procedure. Content of the message B is similar to content of the message 2 and message 4 above, and may include a response for contention resolution (a contention resolution identifier, a random access preamble identifier, or a UE identity, etc.), a fallback indication, a backoff indication, a timing advance command, an uplink grant, and a corresponding response RRC message used to respond to the RRC message contained in the message A. Compared to the four-step random access, the two-step random access procedure can shorten latency of random access. Generally, the network side may configure different random access resource configurations for the two-step random access and the four-step random access.

The UE may trigger a random access procedure in various cases, e.g., initial access executed by switching from an RRC idle state or an RRC inactive state (RRC_INACTIVE) to an RRC connected state, a beam recovery request, a handover (which may also be referred to as synchronous reconfiguration in NR), etc., the UE in the RRC connected state encountering arrival of uplink data but experiencing uplink asynchronization at this time, the UE in the RRC connected state having no available physical uplink control channel (PUCCH) resource, etc. After triggering the random access procedure, the UE selects the two-step random access or the four-step random access and selects CBRA or CFRA for the initiated random access procedure based on configurations on the network side and a measurement result of the UE. In addition, the UE may fall back to the four-step random access procedure from the two-step random access, for example, when the UE receives a fallback random access response (fallbackRAR) from the network side, or when the number of sending attempts of the message A during the two-step random access exceeds the maximum number of times configured, etc. The random access procedure in the present disclosure includes, but is not limited to, the above random access procedures.

### Random Access (RA) Report:

In the current NR system, the UE reports, to the network side, a report related to RA information in mainly three scenarios.

In an RA information report of a first type, the UE records, in a variable VarRA-Report, RA information for each successfully completed random access procedure. For a random access report (referred to as an RA report) that records information about a successfully completed random access procedure, the base station delivers, to the UE, a UE information request (UEinformationRequest) message, which includes an RA report request indication (ra-ReportReq information element) for requesting the UE to report a stored RA report of a random access procedure. After receiving the UEinformationRequest message including the indication, the UE reports the stored RA report to the base station in a UE information response (UEinformationReponse) message. The base station uses an RA report reported by one UE as a sample. With sufficient samples, the base station can analyze whether current RACH performance meets requirements, and adjust RACH parameters as required to improve RACH performance.

A second type of report related to RA information is a connection establishment failure (CEF) report. If initial access fails (an RRC connection establishment procedure fails or an RRC connection resume procedure fails), a corresponding CEF report also stores random access information of a random access procedure executed during the RRC connection establishment/resume procedure. If the UE has a stored CEF report in a variable VarConnEstFailReport, the UE may include a connEstFailInfoAvailable information element in an RRC message such as an RRC resume complete message to notify the base station that the UE has the stored CEF report. The base station delivers, to the UE, a UEinformationRequest message, which includes a CEF report request indication (a connEstFailReportReq information element) for requesting the UE to report stored CEF report information. After receiving the UEinformationRequest message including the indication, the UE reports the stored CEF report (a ConnEstFailReport information element) to the base station in a UEinformationReponse message.

A third type of report related to RA information is a radio link failure (RLF) report. For example, when a radio link failure is triggered due to a random access failure, corresponding random access information may also be stored in a corresponding radio link failure report. If the UE has a stored RLF report in a variable VarRLF-Report, the UE may include an rlf-InfoAvailable information element in an RRC message such as an RRC resume complete message to notify the base station that the UE has the stored RLF report. The base station delivers, to the UE, a UEinformationRequest message, which includes a radio link failure report request indication (an rlf-ReportReq information element) for requesting the UE to report stored RLF report information. After receiving the UEinformationRequest message including the indication, the UE reports a stored RLF report (an rlf-Report information element) to the base station in a UEinformationReponse message. If a random access procedure is executed during the RLF procedure (for example, the RLF is triggered due to a random access failure), the RLF report may include information about the random access procedure.

In general, an RA report refers to the first type of RA information report. In the following embodiments of the present disclosure, a specific implementation method is described by taking an RA report as an example, but it should be noted that the implementation method is also applicable to the second or third type of RA information report.

An RA report in LTE includes two pieces of information about a random access procedure: one is the number of random access preambles sent (numberofpreamblesent), which is used to indicate the number of random access preambles sent in the random access procedure and which corresponds to a PREAMBLE_TRANSMISSION_COUNTER count value of a MAC layer; the other is a contention detection indication (contentiondetected), which is used to indicate whether contention is detected for at least one sent random access preamble. The RACH parameters that can be adjusted by the base station may include RACH resource configuration, random access preamble division (for example, division into dedicated preambles, or dividing preambles into group A and group B), a RACH backoff parameter, a RACH transmit power control parameter, and so on.

A network optimization structure in the NR system of release 16 uses the above framework in LTE, and is enhanced with reference to characteristics of NR such as beam characteristics. The NR system supports a UE in storing RA information corresponding to a plurality of random access procedures. When the UE successfully completes one random access procedure, if the UE determines that the number of Ra-report entries in a random access report list ra-ReportList stored in a current variable VarRA-Report of the UE is less than the maximum RA report number maxRAReport supported by the system, the UE adds a new entry to VarRA-Report to record information about this successfully completed random access procedure. Information about one random access procedure includes: Information about a cell (a global cell identity, a tracking area code, or a physical cell identity and a carrier frequency) in which a random access preamble is sent, random access purpose information, and random access common information. The random access common information includes reference downlink frequency information (e.g., an absolute frequency of point A, a sub-carrier spacing, bandwidth location information locationAndBandwidth, etc.) associated with the random access procedure, and RA information associated with each random access attempt arranged in order of occurrence time. The RA information associated with each random access attempt includes a beam index value, the number of consecutive random access attempts on the beam (i.e., the number of consecutive random access preambles sent corresponding to the beam), whether indication information of random access contention is detected, and indication information of whether a reference signal received power (RSRP) of a beam corresponding to a random access resource used by the random access attempt is higher than a configured threshold. RA information for the two-step random access procedure is added to an RA report of release 17, including: fallback information for fallback from the two-step random access procedure to the four-step random access procedure, downlink quality measured by the UE before the two-step random access procedure is triggered, etc.

The UE is allowed to store up to 8 RA reports in the NR. After entering the RRC idle or inactive state, the UE still stores a previously generated RA report. The UE sends the stored RA report to the network side after entering the connected state again.

Small data transmission (SDT) mechanism:

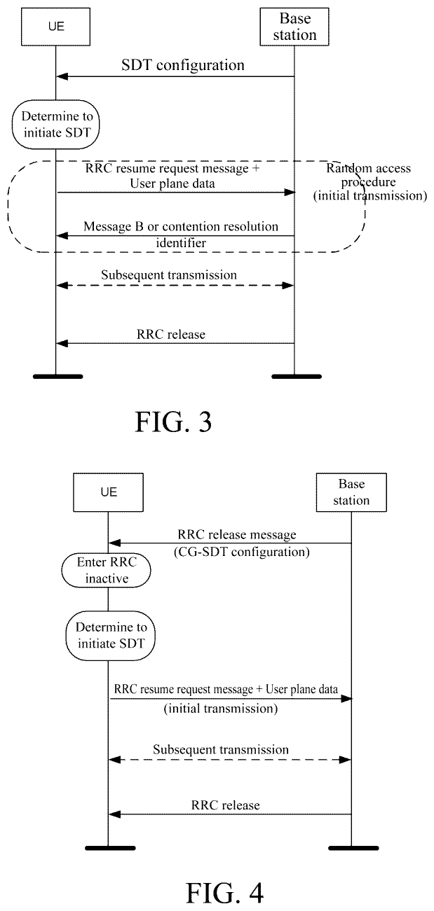

The small data transmission (SDT) mechanism in the NR system of R17 implements transmission of small data packets in the RRC_INACTIVE state. There are two implementations of the SDT mechanism: random access-SDT (RA-SDT) and configured grant-SDT (CG-SDT). FIG. 3 is a schematic flowchart showing an RA-SDT procedure. As shown in FIG. 3, when data is to be transmitted on a radio bearer configured with SDT on UE in the RRC_INACTIVE state, the UE sends a small data transmission request to a network side by using an SDT-specific PRACH resource in a random access procedure, and the network side thus knows that the UE is to perform small data transmission in the RRC_INACTIVE state, and therefore does not configure the UE to enter the RRC connected state. Subsequently, the UE transmits small data to the network side in the message A of the two-step random access procedure or in the message 3 of the four-step random access procedure, wherein the message A or the message 3 includes an RRC resume request message. If all small data is successfully transmitted in the message 3 or message A (i.e., a data buffer corresponding to the SDT-enabled radio bearer or a logical channel is empty), the UE determines, after receiving a response message including an RRC release message from the network side, that the SDT procedure ends; or if not all small data is transmitted (i.e., an uplink buffer of the UE still has uplink small data that has not been transmitted), after random access is successfully completed, the network side schedules, by using a radio network identifier (e.g., a cell-radio network temporary identifier (C-RNTI)) dedicated to the UE, the UE to complete uplink or downlink small data transmission; and when all the small data is transmitted, the SDT procedure ends. In the SDT procedure, if the UE encounters arrival of non-SDT uplink data (data on an SDT-unenabled radio bearer), the UE may execute uplink data transmission by sending a corresponding message to the network side to request to enter the RRC connected state or by autonomously falling back to a conventional non-SDT procedure.

FIG. 4 is a schematic flowchart showing an SDT procedure based on a CG-SDT mechanism. As shown in FIG. 4, in a CG-SDT mechanism, a network side configures UE with CG-SDT resources for small data transmission. Generally, CG-SDT configurations are included in an RRC release message. After receiving the message, the UE releases an RRC connection, enters the RRC_INACTIVE state, and applies the CG-SDT configurations. The CG-SDT configurations include semi-static uplink grant resources for uplink data transmission and corresponding L2 and L1 configurations. Generally, the resources are periodic resources. When data is to be transmitted on a radio bearer configured with SDT on the UE in the RRC_INACTIVE state and a CG-SDT initiation condition is satisfied, the UE does not need to initiate a random access procedure, but directly uses a configured CG to transmit small data, and completes remaining small data transmission by listening to scheduling information of the base station on a downlink channel.

As described above, SDT not only supports transmission of a single packet, but also supports transmission of a plurality of packets. In the SDT procedure, data transmitted for the first time includes common control channel (CCCH) data (an RRC resume request message) and user plane data, and is referred to as initial transmission or initial physical uplink shared channel (PUSCH) transmission, and transmission of the user plane data executed thereafter is referred to as subsequent transmission or subsequent PUSCH transmission. In RA-SDT, the initial transmission generally refers to PUSCH transmission following the message A or message 3, and the subsequent transmission occurs after an initial random access (RA) procedure is successfully completed. In CG-SDT, the initial transmission uses an allocated CG resource, while the subsequent transmission may use an allocated CG resource as well as a dynamic grant. The UE performs the subsequent transmission only after confirming that the initial transmission is successful. In a process of the subsequent transmission, for RA-SDT, if the UE experiences uplink asynchronization (i.e., a corresponding uplink time alignment timer times out), the UE may initiate another random access procedure to achieve uplink synchronization; For CG-SDT, if the UE has no available uplink PUCCH resource to send a scheduling request (SR), the UE initiates a random access procedure during the CG-SDT procedure to acquire uplink resources to continue with uplink data transmission.

The UE remains in the RRC_INACTIVE state throughout the whole SDT procedure, thereby greatly reducing signaling overhead resulted from a conventional data transmission process, reducing energy consumption of the UE, and shortening latency of data transmission.

The UE can initiate and use an SDT procedure for data transmission only if conditions for initiating the SDT procedure are satisfied. These conditions may include: the network side configures resources for SDT (e.g., SDT-specific PRACH configurations) through system information or UE-specific signaling; a radio bearer (RB) associated with uplink data to be transmitted by the UE is enabled to use an SDT procedure; downlink quality (e.g., reference signal received power (RSRP)) of a master cell (i.e., a cell camped on in the RRC_INACTIVE state) of the UE is greater than or equal to a configured link quality threshold TH1; and an amount of uplink data to be transmitted by the UE is less than or equal to a configured data amount threshold TH2; etc. For CG-SDT, the conditions further include: the UE has valid uplink time alignment (i.e., an uplink time alignment timer cg-SDT-TimeAlignmentTimer for SDT is in a running state) and downlink quality RSRP of the master cell of the UE is greater than or equal to a configured link quality threshold TH3.

When the RRC layer initiates an SDT procedure, an SDT timer T319a is started, and an RRC resume procedure is initiated to send an RRC resume request message. The timer T319a is used to monitor the SDT procedure. The timer is stopped when the SDT procedure is ended, for example, when the UE receives an RRC release message, an RRC rejection message, an RRC resume message, or an RRC establishment message, or when the UE performs cell re-selection, or when the SDT procedure fails. If the timer T319a times out, it is considered that the SDT has failed, and the UE executes an operation of entering the RRC_IDLE state. In the current SDT mechanism, the RRC layer of the UE considers that an SDT operation fails when one or more of the following cases occur: the timer T319a times out; RA fails during the SDT procedure; an indication that the maximum number of retransmissions has been reached is received from a radio link control layer (RLC) of a master cell group while the SDT procedure is ongoing; an indication of an integrity check failure is received from a lower layer while the SDT procedure is ongoing; and while the SDT procedure is ongoing, the lower layer indicates that a timer cg-SDT-TimeAlignmentTimer or a timer configuredGrantTimer times out before a network response sent with respect to uplink CG-SDT is received, etc. If the SDT procedure fails, the UE executes an operation of entering the RRC idle state. Herein, the UE considering that the SDT procedure has failed is equivalent to the UE considering that the SDT procedure is not running.

The characteristics of these SDT procedures described above make the SDT procedures distinctive from a conventional RRC resume procedure or an RA procedure. Performing distinctive collection and recording for RA reports in different scenarios and performing more re-fined network status monitoring enable the network side to have more re-fined and accurate network parameters such as random access parameters or SDT resource configurations in different scenarios. In SON discussions of release R18, the 3GPP working group agreed to enhance an SDT-related SON, including: when an SDT operation fails, including corresponding RA information and SDT information in an RA report. Other specific information is not yet defined. Such a conclusion enables the RA report to include both RA information for a successful SDT procedure and RA information for a failed SDT procedure. Alternatively, further, the RA report may include both RA information for a successful RA procedure in an SDT procedure and RA information for a failed RA procedure in the SDT procedure. Based on information in an existing RA report, the network side cannot know whether a corresponding SDT procedure or RA procedure is successful or failed after receiving an RA report related to the SDT procedure. This becomes a concern of the present disclosure. In addition, as described above, the UE may also initiate an RA procedure in a subsequent transmission process of SDT due to uplink asynchronization or no available PUCCH resources. In this case, the UE experiences an SDT procedure in the RRC_INACTIVE state. This is different from a conventional RA procedure initiated by the UE in the connected state. Based on the current RA report, the network side cannot know whether the RA procedure occurs during the SDT procedure or during a subsequent transmission process following the SDT procedure. This problem also becomes a concern of the present disclosure to be addressed.

The present disclosure mainly provides a solution to the above problems related to RA reporting in an SDT-supported scenario. The following embodiments of the present disclosure provide specific implementations. With the solution of the present disclosure, the UE includes SDT-related information in an RA report, so that the network side can know from the RA report whether an SDT procedure in an SDT scenario is successful, or whether an RA procedure corresponding to the RA report occurs during the SDT procedure or a specific phase of the SDT procedure, thereby executing more re-fined network parameter optimization such as optimization on random access parameters or SDT parameter configurations corresponding to SDT. In addition, the present disclosure further provides a method for setting RA-related information in an RA report in an SDT scenario, so that the UE can properly or accurately set the RA-related information in the RA report. In the following embodiments, RA information in an RA report, SDT information in an RA report, RA-related information or SDT-related information in an RA report, etc. are interchangeable.

### Embodiment 1

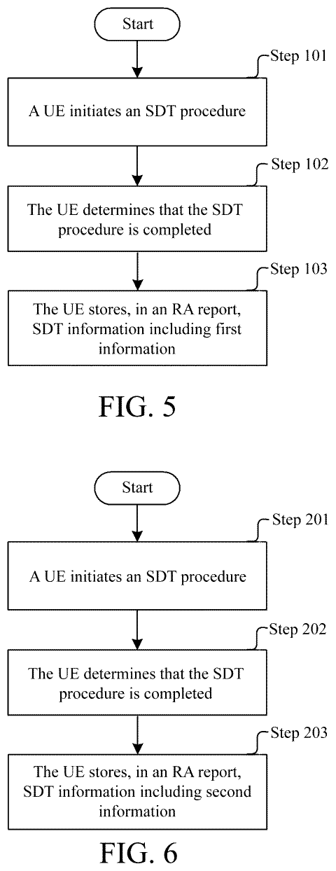

Embodiment 1 provides an RA reporting method in an SDT scenario. The following describes the RA reporting method in Embodiment 1 in detail. FIG. 5 is a schematic flowchart showing an RA reporting method according to Embodiment 1 of the present invention.

Step 101: UE initiates an SDT procedure.

As described above, when an RRC layer of the UE determines that conditions for initiating SDT are satisfied, the UE initiates an SDT procedure, and considers that the SDT procedure is ongoing. After initiating the SDT procedure, the RRC layer of the UE instructs a lower layer to execute data transmission and reception by using an SDT manner. The lower layer refers to layer 2 (L2 ) or layer 1 (L1 ). In an RA-SDT procedure, a MAC layer is triggered to initiate a random access procedure by using an SDT-specific random access resource.

Step 102: The UE ends the SDT procedure.

The end of the SDT procedure may be a successful end or a failed end, or the end of the SDT procedure may alternatively be stated as follows: the UE considers that the SDT procedure is not ongoing. Optionally, when the UE in the SDT procedure receives an RRC release message from a network side, the UE considers that the SDT procedure is successfully completed, and stops a timer T319a. The UE considers that the SDT procedure has a failed end when the UE in the SDT procedure receives an RRC rejection message from the network side, or the timer T319a times out, or RA fails during the SDT procedure, or an indication that the maximum number of retransmissions has been reached is received from a radio link control layer (RLC) of a master cell group while the SDT procedure is ongoing, or an indication of an integrity check failure is received from a lower layer while the SDT procedure is ongoing, or while the SDT procedure is ongoing, the lower layer indicates that a timer cg-SDT-TimeAlignmentTimer or a timer configuredGrantTimer times out before a network response sent with respect to uplink CG-SDT is received. Herein, “end” and “completion” are interchangeable.

Step 103: When the SDT procedure in step 102 ends, for this completed SDT procedure, the UE adds a new entry to an RA report variable VarRA-Report, and includes first information in RA-Report of this entry, wherein the first information is used to indicate whether the SDT procedure is successfully completed.

Optionally, when the SDT procedure achieves a successful completion, the first information is set to “TRUE”, else, when the SDT procedure has an unsuccessful completion or a failed completion, the first information is not included in RA-Report, i.e., the first information is not present in RA-Report, or the first information is set to “FALSE” in this case. Optionally, vice versa, when the SDT procedure has an unsuccessful completion, i.e., when the SDT procedure fails, the first information is set to “TRUE”, else, when the SDT procedure achieves a successful completion, the first information is not included in RA-Report, i.e., the first information is not present in RA-Report, or the first information is set to “FALSE” in this case.

Subsequent transmission is transmission in the SDT procedure of a data packet not transmitted together with a common control channel CCCH message. At this time, transmission (i.e., initial transmission) of a data packet including both the CCCH message and user plane data has been successfully completed. Alternatively, the subsequent transmission refers to uplink transmission other than the initial transmission, and for RA-SDT, refers to uplink transmission execute after an initial RA procedure is successfully completed. The CCCH message is an RRCResumeRequest message. Preferably, the user plane data in the present disclosure is a data radio bearer (DRB). Alternatively, the user plane data also includes a signaling radio bearer (SRB), such as SRB2. Preferably, the data packet in the present disclosure refers to an L2 data packet, such as a medium access control (MAC) protocol data unit (PDU) or a MAC service data unit (SDU).

### Embodiment 2

This embodiment provides an RA reporting method in another SDT scenario. The following describes the RA reporting method in Embodiment 2 in detail. FIG. 6 is a schematic flowchart showing an RA reporting method according to Embodiment 2 of the present invention.

Step 201: UE initiates an RA procedure. The RA procedure is triggered by an RA-SDT procedure.

As described above, when an RRC layer of the UE determines that conditions for initiating SDT are satisfied, the UE initiates an SDT procedure, and considers that the SDT procedure is ongoing. After initiating the SDT procedure, the RRC layer of the UE instructs a lower layer to execute data transmission and reception by using an SDT manner. In the RA-SDT procedure, a MAC layer is triggered to initiate the RA procedure by using an SDT-specific random access resource.

Step 202: The UE completes the initial RA procedure in the RA-SDT procedure. A completion of the RA procedure is either a successful completion or a failed completion.

Optionally, the RA procedure refers to the first RA procedure in the RA-SDT procedure, rather than that occurring in a subsequent transmission phase in the RA-SDT procedure.

Step 203: When the RA procedure in step 202 is completed, for this completed RA, the UE adds a new entry to an RA report variable VarRA-Report, and includes second information in RA-Report of this entry, wherein the second information is used to indicate whether the RA procedure for SDT is successfully completed. Further, the second information is used to indicate whether the RA procedure in the SDT procedure is successfully completed.

Optionally, when the RA procedure achieves a successful completion, the second information is set to “TRUE”, else, when the RA procedure has an unsuccessful completion or a failed completion, the second information is not included in RA-Report, i.e., the second information is not present in RA-Report, or the second information is set to “FALSE” in this case. Optionally, vice versa, when the RA procedure has an unsuccessful completion, i.e., when the RA procedure fails, the second information is set to “TRUE”, else, when the RA procedure achieves a successful completion, the second information is not included in RA-Report, i.e., the second information is not present in RA-Report, or the second information is set to “FALSE” in this case.

### Embodiment 3

Embodiment 3 provides an RA reporting method in still another SDT scenario.

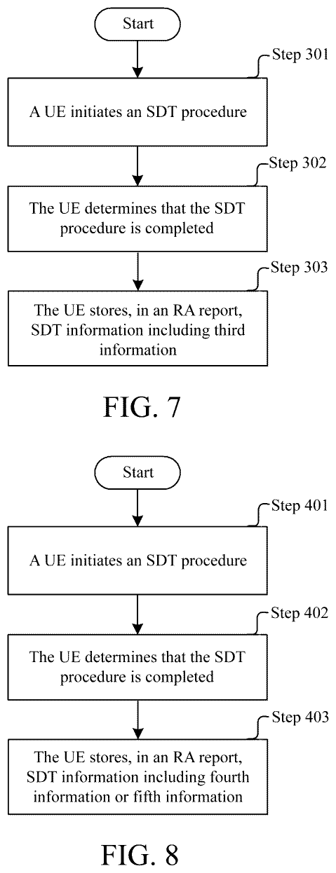

The following describes Embodiment 3 of the present disclosure in detail. FIG. 7 is a schematic flowchart showing an RA reporting method according to Embodiment 3 of the present invention. The RA reporting method of Embodiment 3 may include the following steps.

Step 301: UE initiates an RA procedure. The RA procedure is triggered during an SDT procedure.

As described above, when an RRC layer of the UE determines that conditions for initiating SDT are satisfied, the UE initiates an SDT procedure, and considers that the SDT procedure is ongoing. After initiating the SDT procedure, the RRC layer of the UE instructs a lower layer to execute data transmission and reception by using an SDT manner. In the RA-SDT procedure, a MAC layer is triggered to initiate the RA procedure by using an SDT-specific random access resource. In addition, in a subsequent transmission phase of SDT, the UE may also initiate an RA procedure.

Step 302: The UE completes the RA procedure. Optionally, a completion of the RA procedure refers to an unsuccessful completion or a failed completion of the RA procedure.

Optionally, the completion of the RA procedure may also be a successful completion of the RA procedure.

Step 303: When the RA procedure in step 302 is completed, for this completed RA, the UE adds a new entry to an RA report variable VarRA-Report, and includes third information in RA-Report of this entry, wherein the third information is used to indicate whether the RA procedure is the first RA procedure in the SDT procedure. In other words, the third information is used to indicate whether the RA procedure is an RA procedure for initial transmission or an RA procedure for subsequent transmission.

Optionally, when the RA procedure is the first RA procedure in the SDT procedure or the RA procedure is an RA procedure for initial transmission, the third information is set to “TRUE”, else, when the RA procedure is not the first RA procedure in the SDT procedure or the RA procedure is not an RA procedure for initial transmission (i.e., an RA procedure for subsequent transmission), the third information is not included in RA-Report, i.e., the third information is not present in RA-Report, or the third information is set to “FALSE” in this case.

Optionally, the SDT procedure refers to an RA-SDT procedure.

### Embodiment 4

Embodiment 4 provides an RA reporting method in yet another SDT scenario. FIG. 8 is a schematic flowchart showing an information reporting method according to Embodiment 4 of the present invention. As shown in FIG. 8, this embodiment includes the following steps.

Step 401: UE initiates an SDT procedure.

As described above, when an RRC layer of the UE determines that conditions for initiating SDT are satisfied, the UE initiates an SDT procedure, and considers that the SDT procedure is ongoing. After initiating the SDT procedure, the RRC layer of the UE instructs a lower layer to execute data transmission and reception by using an SDT manner. In an RA-SDT procedure, a MAC layer is triggered to initiate a random access procedure by using an SDT-specific random access resource.

Step 402: The SDT procedure achieves a failed completion.

Determination of the failed end of the SDT procedure is as described in Embodiment 1, and details are not described herein again.

Step 403: When the SDT procedure in step 402 ends, for this completed SDT procedure, the UE adds a new entry to an RA report variable VarRA-Report, and includes one or both of the following information in RA-Report of this entry: fourth information, wherein the fourth information is used to indicate a cause of a failure of the SDT procedure; and fifth information, wherein the fifth information is used to indicate whether the failure of the SDT procedure occurs during initial transmission or subsequent transmission. Optionally, for RA-SDT, the fifth information is used to indicate whether the failure of the SDT procedure occurs before the first RA of the SDT procedure is completed or after the first RA is completed.

Optionally, when the SDT failure occurs during the initial transmission or before the first RA of the SDT procedure is completed, the fifth information is set to “TRUE”, else, when the SDT failure does not occur during the initial transmission or before the first RA of the SDT procedure is completed, the fifth information is not included in RA-Report, i.e., the fifth information is not present in RA-Report, or the fifth information is set to “FALSE” in this case. Optionally, vice versa, when the SDT failure occurs during the initial transmission or before the first RA of the SDT procedure is completed, the fifth information is set to “FALSE”, or the fifth information is not included in RA-Report, i.e., the fifth information is not present in RA-Report, else, when the SDT failure does not occur during the initial transmission or before the first RA of the SDT procedure is completed, the fifth information is set to “TRUE” in this case.

Determination of the initial transmission or the subsequent transmission is as described in the above embodiments, and details are not described herein again.

### Embodiment 5

This embodiment provides an RA reporting method in a further SDT scenario.

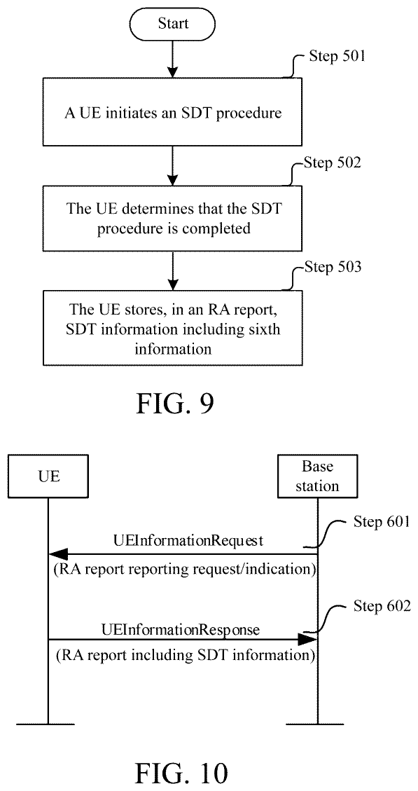

FIG. 9 is a schematic flowchart showing an information reporting method according to Embodiment 5 of the present invention. As shown in FIG. 9, this embodiment includes the following steps.

Step 501: UE initiates an RA procedure. The RA procedure is triggered during an SDT procedure.

As described above, when an RRC layer of the UE determines that conditions for initiating SDT are satisfied, the UE initiates an SDT procedure, and considers that the SDT procedure is ongoing. After initiating the SDT procedure, the RRC layer of the UE instructs a lower layer to execute data transmission and reception by using an SDT manner. In the RA-SDT procedure, a MAC layer is triggered to initiate the RA procedure by using an SDT-specific random access resource. In addition, in a subsequent transmission phase of SDT, the UE may also initiate an RA procedure.

Step 502: The UE completes the RA procedure. A completion of the RA procedure may be a successful completion, or may be an unsuccessful completion or a failed completion.

Step 503: When the RA procedure in step 502 is completed, for this completed RA, the UE adds a new entry to an RA report variable VarRA-Report, and includes sixth information in RA-Report of this entry, wherein the sixth information is used to indicate whether the RA procedure occurs during the SDT procedure. Further, the sixth information is used to indicate whether the RA procedure occurs in a subsequent transmission phase of the SDT procedure.

Optionally, when the RA procedure occurs during the SDT procedure or when the RA procedure occurs in a subsequent transmission phase of the SDT procedure, the sixth information is set to “TRUE”, else, when the RA procedure does not occur during the SDT procedure or when the RA procedure does not occur in a subsequent transmission phase of the SDT procedure, the sixth information is not included in RA-Report, i.e., the sixth information is not present in RA-Report, or the sixth information is set to “FALSE” in this case.

Optionally, the SDT procedure refers to an RA-SDT procedure.

Optionally, the UE includes the above sixth information in RA-Report only when a value of a raPurpose field in RA-Report is set to ulUnSynchronized or noPUCCHResourceAvailable. The raPurpose field is used to indicate a cause or an RA scenario for which the UE triggers the RA procedure for RA-Report. When the RA procedure is resulted from arrival of uplink/downlink data and uplink asynchronization (a time alignment timer is not running), raPurpose is set to ulUnSynchronized, and when the RA scenario is that the UE has no available PUCCH resource, raPurpose is set to noPUCCHResourceAvailable.

### Embodiment 6

This embodiment provides an RA reporting method executed by UE. By means of the method described in this embodiment, the UE can report, in an RA report, SDT-related information to a base station, so as to provide more accurate RA information to the network side. This embodiment provides a method for a signaling flow when a UE reports the RA report in the above embodiments by means of an RRC procedure.

FIG. 10 is a schematic flowchart showing an information reporting method according to Embodiment 6 of the present disclosure. As shown in FIG. 10, the information reporting method in Embodiment 6 of the present disclosure may include the following steps.

Step 601: UE receives a UE information request UEInformationRequest message from a network side, wherein the UEInformationRequest message carries an instruction/request used to request the UE to report a stored RA report.

Step 602: The UE includes, in a UE information response UEInformationResponse message, content in the stored RA, and sends the UEInformationResponse message to the network side. The RA report included in the UEInformationResponse message includes at least one or more combinations of the first information to the sixth information in the above embodiments.

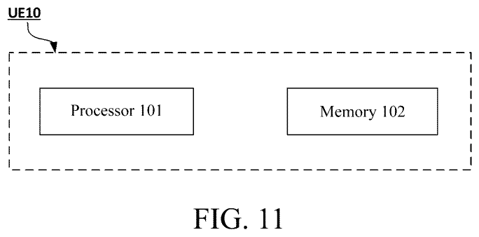

FIG. 11 is a block diagram showing a user equipment 10 according to an embodiment of the present disclosure. As shown in FIG. 11, the user equipment 10 includes a processor 101 and a memory 102. The processor 101 may include, e.g., a microprocessor, a microcontroller, an embedded processor, etc. The memory 102 may include, e.g., a volatile memory (such as a random access memory (RAM)), a hard disk drive (HDD), a non-volatile memory (such as a flash memory), or other memories. The memory 102 has program instructions stored thereon. The instructions, when run by the processor 101, may execute the random access reporting method applied to the user equipment described in detail in the present disclosure.

The program running on the device according to the present disclosure may be a program that enables a computer to implement the functions of the embodiments of the present disclosure by controlling a central processing unit (CPU). The program or information processed by the program may be temporarily stored in a volatile memory (e.g., a random access memory (RAM)), a hard disk drive (HDD), a non-volatile memory (e.g., a flash memory), or other memory systems.

The program for implementing the functions of the embodiments of the present disclosure may be recorded on a computer-readable recording medium. The corresponding functions may be achieved by reading programs recorded on the recording medium and executing the programs by a computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (e.g., monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present disclosure may also be implemented using these new integrated circuit technologies.

Furthermore, the present disclosure is not limited to the embodiments described above. Although various examples of the described embodiments have been described, the present disclosure is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present disclosure have been described in detail above with reference to the accompanying drawings. However, the specific structures are not limited to the above embodiments. The present disclosure also includes any design modifications that do not depart from the substance of the present disclosure. In addition, various modifications may be made to the present disclosure within the scope of the claims. Embodiments resulted from the appropriate combinations of the technical means disclosed in different embodiments are also included within the technical scope of the present disclosure. In addition, components with the same effect described in the above embodiments may be replaced with one another.

1-8. (canceled)

9. A user equipment (UE), comprising:
a processor; and
a memory storing instructions,
wherein the processor is configured by the instructions to cause the UE to:
initiate a random access small data transmission (RA-SDT) procedure;
after the RA-SDT procedure ends, add a new entry to an RA report; and
if the RA-SDT procedure failed, include, in the new entry, first information set to “TRUE”, wherein,
if the RA-SDT procedure was successfully completed, the first information is absent in the new entry.

10. The UE according to claim 9, wherein
if the RA-SDT procedure failed, the processor is further configured by the instructions to cause the UE to include, in the new entry, second information that indicates a cause of the failure of the RA-SDT procedure.

11. A method performed by a user equipment (UE), comprising:
initiating a random access small data transmission (RA-SDT) procedure;
after the RA-SDT procedure ends, adding a new entry to an RA report; and
if the RA-SDT procedure failed, including, in the new entry, first information set to “TRUE”,
if the RA-SDT procedure was successfully completed, the first information is absent in the new entry.
